(19) United States
(12) Patent Application Publication
(10) Pub. No.: US 2009/0256009 A1
(43) Pub. Date: Oct. 15, 2009

(54) Protection device for a lower guide system of a fuel injector

(76) Inventors: Robert B. Perry, Leicester, NY (US); Kevin J. Allen, Avon, NY (US); Charles W. Braun, Livonia, NY (US)

Correspondence Address: DELPHI TECHNOLOGIES, INC., M/C 480-410-202, PO BOX 5052, TROY, MI, 48007, US

(21) Appl. No.: 12/082,382

(22) Filed: Apr. 10, 2008

(51) Int. Cl. B05B 1/30

(52) U.S. Cl. 239/575

(57) ABSTRACT

A protection device for a lower guide system of a fuel injector includes a debris shield deflecting a fuel flow around a lower guide system and a particle trap collecting particles contained within the fuel flow. By deflecting the fuel flow towards flow passages around the lower guide system, the particles contained in the fuel flow are prevented from entering a lower guide area, such as a radial gap between the stationary components of the lower guide system and the moving component of the valve assembly. The particle trap may be defined in a lower housing of the fuel injector or may be integrated in the debris shield. The debris shield may be integral with a valve assembly or may be a separate component. A permeable area may be integrated in the debris shield to enable partial flow therethrough.

### TECHNICAL FIELD

The present invention relates to fuel injection systems of internal combustion engines; more particularly, to solenoid actuated fuel injectors; and most particularly, to a debris shield that protects a lower guide of the fuel injector.

### BACKGROUND OF THE INVENTION

Fuel injected internal combustion engines are well known. Fuel injection is a way of metering fuel into an internal combustion engine. Fuel injectors are electro-mechanical devices that deliver fuel in precise amounts and times to the combustion system of an engine.

Generally, an electromagnetic fuel injector incorporates a solenoid armature pintle assembly, located between the pole piece of the solenoid and a fixed valve seat. The armature pintle assembly typically operates as a movable valve assembly and, therefore, represents the moving mass of the fuel injector. Electromagnetic fuel injectors are linear devices that meter fuel per electric pulse at a rate proportional to the width of the electric pulse. When an injector is energized, a magnetic field builds and attracts the movable armature assembly toward the pole piece, compressing the return spring, and lifts the valve from the seat, allowing fuel to flow into the engine. The internal valve assembly may include a beveled circular seat and a reciprocably actuated ball that seals against the seat in a circular sealing line.

It is most desirable, in a modern internal combustion engine, to precisely control the flow of fuel to the combustion chamber in order to meet performance requirements as well as emission regulations. Therefore, it is desirable to ensure that the ball quickly and completely seals against the seat. Contamination between the ball and seat may be caused by internally generated particles which may lead to a malfunction of the injector and, therefore needs to be prevented.

Furthermore, the moving mass of a fuel injector must be guided in a radial direction in order for the seal surfaces in the closing direction and the impact surfaces in the opening direction to be functional and precise. Such a guide system, which may include an upper guide system position proximate to the armature and a lower guide system positioned proximate to the seal surface where the ball seals against the seat, is required to operate at a low and consistent friction force in order for the injector to meter accurate fuel amounts and in order to provide a fuel flow rate within an established tolerance for the life of the parts of the armature pintle assembly. The guidance of the moving mass of the fuel injector is critical to function, performance, and durability of the injector. The dimensional tolerances of the lower guide system and the moving mass are extremely tight to ensure that the valve assembly shuts off the flow as quickly and consistently as possible. Because of this requirement, the radial gap between the moving component of the valve assembly and the stationary component of the lower guide is very small, typically of the order of about 5 to 10 microns. Built-in contamination, as well as self-generated wear debris, has the tendency to get trapped in the vicinity of this small gap. Trapped particles have the potential to damage the components of the lower guide system and to increase the friction force acting on the moving mass of the injector. This damage can lead to premature failure of the injector. Furthermore, an increased and/or inconsistent friction force acting on the moving mass of the injector may lead to a reduction in the injector performance.

It is known to position an upper filter proximate to a fuel inlet of the injector. While the upper filter may capture contaminants generated upstream of the fuel injector, it cannot capture contaminants that may be generated during the assembly and/or operation of the fuel injector. Contaminants may be generated within the fuel injector, for example, during injector assembly operations, such as an assembly tooling or gauging, due to insufficient cleaning of the fuel injector parts prior to assembly, or during operation of the fuel injector, for example, due to friction. It is currently not possible to completely eliminate such internal contamination of a fuel injector.

In order to further reduce contamination of the fuel flowing through the injector with particles of internal origin, filters have been disposed internally of the fuel injector between the fuel inlet and the internal valve assembly in the prior art. While such internal filters may prevent internally generated contaminants from reaching the internal valve assembly, integration of such prior art internal filters adds a filter component to the injector assembly, adds components needed to retain the filter components to the injector assembly, and adds internal filter assembly process steps to the assembly process of the injector.

What is needed in the art is an apparatus and method that effectively and economically prevents internal contaminants from entering the gap between a stationary component of a lower guide system and a moving component of a valve assembly of an injector.

It is a principal object of the present invention to provide a debris shield that protects a lower guide system of a fuel injector.

It is a further object of the invention to prevent debris particles from entering the sealing surface between the seat and the ball of a valve assembly of a fuel injector.

### SUMMARY OF THE INVENTION

Briefly described, the present invention provides protection for lower components of a fuel injector vulnerable to damage from debris particles suspended in fuel flowing through the fuel injector. A component that deflects the fuel flow towards flow passages around a lower guide system for a valve assembly of a fuel injector is attached to a pintle of the valve assembly. By deflecting the fuel flow towards flow passages around the lower guide system, the particles contained in the fuel flow are prevented from entering a lower guide area, such as a radial gap between the stationary components of the lower guide system and the moving component of the valve assembly. A particle trap that operates to trap debris particles before they enter a valve seat of the fuel injector may be defined in a lower housing of the fuel injector or may be integrated in the debris shield.

In one aspect of the invention, the shield may be a feature integral with the pintle of the valve assembly. In another aspect of the invention, the shield may be a separate component that is attached to the pintle of the valve assembly. Various features such as mesh material or flapper valves may be integrated in the debris shield to enable partial flow therethrough.

### BRIEF DESCRIPTION OF THE DRAWINGS

The present invention will now be described, by way of example, with reference to the accompanying drawings, in which:

FIG. 1 is a cross-sectional view of a lower housing of a fuel injector, in accordance with a first embodiment of the invention;

FIG. 2 is an isometric view of an assembled debris shield, in accordance with the first embodiment of the invention;

FIG. 3 is an isometric view of another assembled debris shield, in accordance with the first embodiment of the invention;

FIG. 4 is a cross-sectional view of still another assembled debris shield, in accordance with the first embodiment of the invention;

FIG. 5 is a cross-sectional view of a lower housing of a fuel injector with an integral debris shield, in accordance with the first embodiment of the invention;

FIG. 6 is a cross-sectional view of a lower housing of a fuel injector, in accordance with a second embodiment of the invention;

FIG. 7 is an isometric view of an assembled debris shield, in accordance with the second embodiment of the invention;

FIG. 8 is an isometric view of another assembled debris shield, in accordance with the second embodiment of the invention; and

FIG. 9 is a cross-sectional view of still another assembled debris shield, in accordance with the second embodiment of the invention.

Corresponding reference characters indicate corresponding parts throughout the several views. The exemplification set out herein illustrates referred embodiments of the invention, in one form, and such exemplification is not to be construed as limiting the scope of the invention in any manner.

### DESCRIPTION OF THE PREFERRED EMBODIMENTS

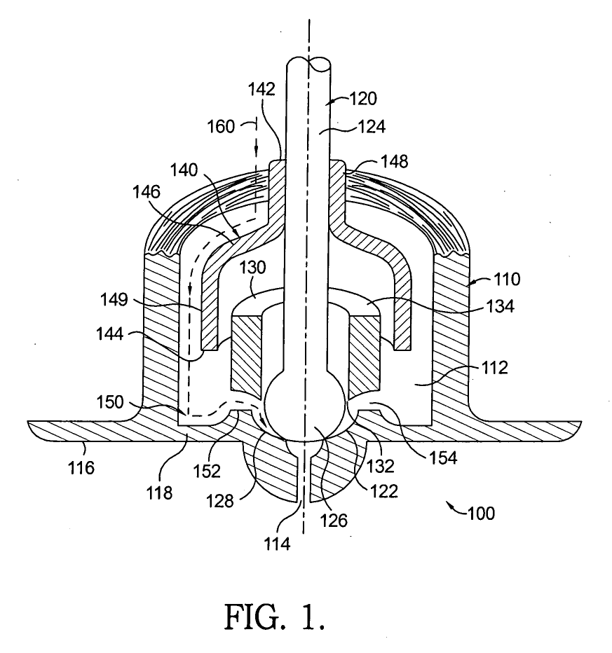

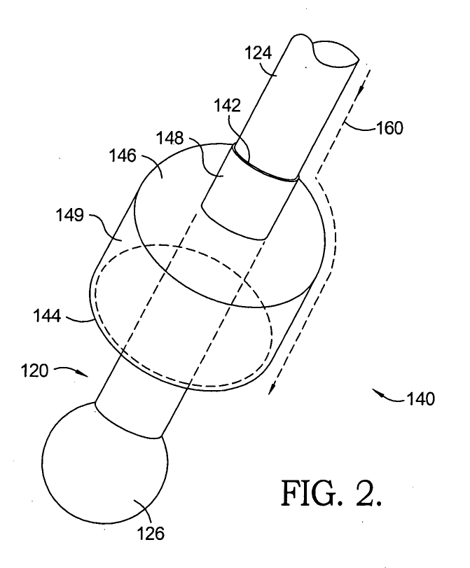

Referring to FIGS. 1 and 2, a fuel injector 100 in accordance with a first embodiment of the invention includes a lower housing 110 enclosing a fuel passage 112, a valve assembly 120 disposed within fuel passage 112, and a lower guide system 130 guiding valve assembly 120. The fuel flow 160 within fuel passage 112 is directed towards a fuel outlet 114 positioned proximate to a lower end 116 of lower housing 110. Fuel injector 100 may be a solenoid actuated fuel injector and, thus, may be a linear device that meters fuel per electric pulse at a rate proportional to the width of the electric pulse. Fuel injector 100 may be, but is not limited to, a fuel injector for port fuel or direct fuel injection.

Valve assembly 120 includes a pintle shaft 124 and a valve, such as a ball 126, that is attached at one end of pintle shaft 124. Ball 126 seals against a valve seat, such as a beveled circular seat 122, for example, in a circular sealing area 128. Valve seat 122 may be formed integral with a lower end wall 118 of lower housing 110 proximate to fuel outlet 114 or may be formed as a separate part that is assembled into lower housing 110 at lower end 116. Valve assembly 120 is positioned upstream of and proximate to fuel outlet 114 within lower housing 110 of fuel injector 100. Valve assembly 120 is assembled within lower housing 110 for reciprocating movement in axial direction within fuel passage 112. Valve assembly 120 regulates fuel flow 160 through fuel outlet 114.

Lower guide system 130 is preferably positioned in close proximity to valve seat 122 and, accordingly, to sealing area 128 and typically fits closely around moving elements of valve assembly 120 to enable valve assembly 120 to shut off the flow of fuel through valve seat 122 as quickly as possible. Because of this engineering requirement, a lower guide area 132, such as a radial gap, between the moving components, such as ball 126, and the stationary component, such as lower guide system 130 is very small, for example, in the order of 5-10 microns. To protect lower lo guide area 132 from particles contained in fuel flow 160, such as built in contamination or self-generated wear debris, a debris shield 140 may be positioned upstream of lower guide system 130 within fuel passage 112. Debris shield 140 may be integral with pintle shaft 124 or may be a separate part that is attached to pintle shaft 124.

Debris shield 140 is designed to deflect fuel flow 160 to flow around lower guide is 130 thereby not allowing the particles contained in fuel flow 160 to enter lower guide area 132. Debris shield 140 may have the shape of an umbrella or cup that is in a sealed connection with pintle shaft 124 at a first end 142 and open at a second end 144. Debris shield 140 includes an attachment collar 148 that is used to couple debris shield 140 to a pintle shaft 124, a shoulder 146 that extends radially outwards from attachment collar 148, and a cylindrical section 149 that extends axially downwards from shoulder 146 to second end 144.

Attachment collar 148 is positioned at first end 142. Attachment collar 148 may be formed integrally with pintle shaft 124 or may be attached to pintle shaft 124. Attachment collar 148 ensures that debris shield 140 moves with pintle shaft 124. Shoulder 146 may have a conical shape. Cylindrical section 149 extends preferably beyond an upper end 134 of lower guide system 130 such that cylindrical section 149 is positioned between an inner circumferential contour of lower housing 110 and an outer circumferential contour of lower guide system 130 at second end 144 of debris shield 140. Accordingly, the diameter of circular second end 144 is adapted to loosely fit over an outer circumferential contour of lower guide system 130. Consequently, fuel flow 160 passes over debris shield 140 and does not enter lower guide area 132.

A particle trap 150 is integrated in lower end wall 118 of lower housing 110 to surround valve seat 122. If valve seat 122 is formed as a separate part, particle trap may be integrated in valve seat 122 adjacent to sealing area 128. A lip 152 integral with lower end wall 118 extends axially into flow passage 112 and separates particle trap 150 from valve seat 122 and sealing area 128. A relatively tight fuel passage 154 is formed between lip 152 and lower guide system 130. Fuel passage 154 may be realized for example as a series of holes above the floor of particle trap 150. Particle trap 150 is formed as a sump between an inner circumferential contour of lower housing 110 and lip 152. Due to gravity, the particles contained in fuel flow 160 are collected in particle trap after fuel flow 160 passes over debris shield 140 and before fuel flow 160 passes through fuel passage 154. Therefore, particle trap 150 ensures that particles contained in fuel flow 160 are not entering sealing area 128.

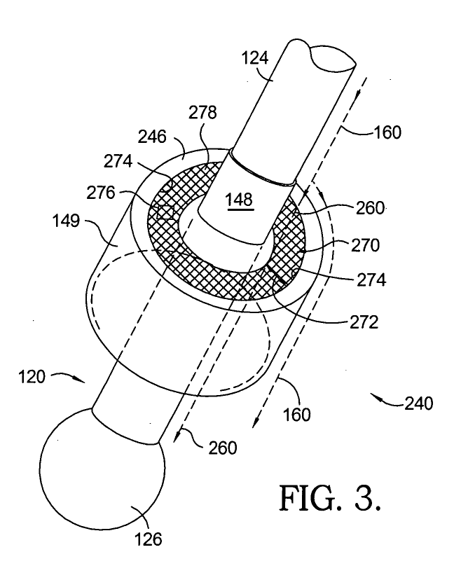

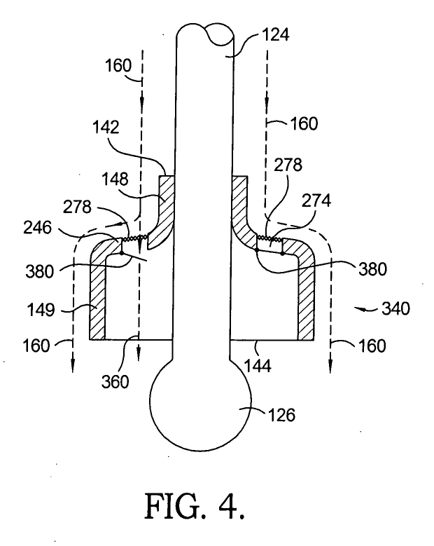

In operation, debris shield 140 may cause generation of hydraulic resistance forces during reciprocating movement of valve assembly 120. As valve assembly 120 raises, a suction force towards the internal volume of debris shield 140 is created that needs to be overcome and, thus, may reduce the speed of the upwards motion of valve assembly 120. The suction force may cause fuel to be trapped inside debris shield 140. When valve assembly 120 is lowered, the trapped fuel may be beneficial, since the speed of valve assembly 120 and the impact force of ball 126 towards seat 122 is reduced. While reducing the impact force of ball 126 towards seat 122 is desired in some applications, it may not be desired in others. Therefore, debris shield 140 may be modified according to various aspects of the invention as described below in reference to FIGS. 3 and 4, to mitigate the hydraulic resistance forces acting upon valve assembly 120 during reciprocating movement while providing protection for lower guide area 132.

Referring to FIG. 3, a debris shield 240 in accordance with the first embodiment of the invention includes a permeable area 270 integrated in a shoulder 246. (Note, features identical with those in fuel injector 100 as shown in FIG. 1 carry the same numbers; features analogous but not identical carry the same numbers but in the 200 series.)

Permeable area 270 is an area that enables a certain amount of fuel flow 160, such as partial fuel flow 260, to axially pass through debris shield 240 in both directions. In addition, permeable area 270 prevents particles contained in fuel flow 160 to pass through debris shield 240 and into lower guide area 132.

While permeable area 270 is shown in FIG. 3 to form a complete circle, it may be possible that permeable area 270 forms only a partial circle. The width 272 of permeable area 270 may be chosen according to the desired flow through debris shield 240. Permeable area 270 may be formed, for example, of a mesh material 278 that is attached to or integrated into shoulder 146 of debris shield 240 covering a previously formed opening 274. It may further be possible to form a plurality of openings 276 that have a smaller surface area than opening 274 in shoulder 246. Openings 276 may be covered with mesh material 278.

Fuel flow 260 mitigates the speed reducing effect of the hydraulic resistance forces acting upon valve assembly 120 by providing a bi-directional purging mechanism that prevents formation of the suction force and suspension of trapped fuel in debris shield 240 during the upwards movement of valve assembly 120. Furthermore, providing partial fuel flow 260 through debris shield 240 increases the volumetric flow rate of fuel flow 160 through fuel injector 100, which may improve the performance capability of fuel injector 100. While debris shield 240 mitigates the hydraulic resistance force in both axial directions, it might be desirable for certain applications to relieve the suction force that reduces the raising speed of valve assembly 120, yet to enable the hydraulic resistance force that reduces the lowering speed of valve assembly 120 and, thus, the impact force of ball 126 on seat 122.

Referring to FIG. 4, a debris shield 340 in accordance with the first embodiment of the present invention includes at least one flapper valve 380 attached to or integral with debris shield 340 and positioned beneath mesh material 278. (Note, features identical with those in fuel injector 100 as shown in FIG. 1 carry the same numbers; features analogous but not identical carry the same numbers but in the 300 series.) Any device that allows flow in only one direction may be used instead of flapper valve 380.

In operation, when valve assembly 120 is moving upwards or is in a raised position, a first portion of fuel flow 160 moves along the outside of debris shield 340 carrying particles included in fuel flow 160 away from lower guide area 132. A second portion of fuel flow 160, such as partial fuel flow 360, flows downwards through mesh material 278 and flapper valve 380 thereby reducing the suction force acting on debris shield 340 and preventing trapping of fuel in debris shield 340 due to a purging mechanism. When valve assembly 120 is moving downwards, thus towards seat 122, flapper valve 380 is forced closed thereby substantially preventing partial fuel flow 360 and reducing the lowering speed of valve assembly 120 and, thus, the impact force of ball 126 on seat 122. While flapper valve 380 is shown in FIG. 4 positioned beneath mesh material 278 and to open downwards, a reverse acting flapper valve 380 positioned above mesh material 178 may be used instead. The reverse acting flapper valve 380 would enable a slower opening of valve assembly 120 and a faster closing of valve assembly 120 compared to the downwards opening flapper valve 380 shown in FIG. 4.

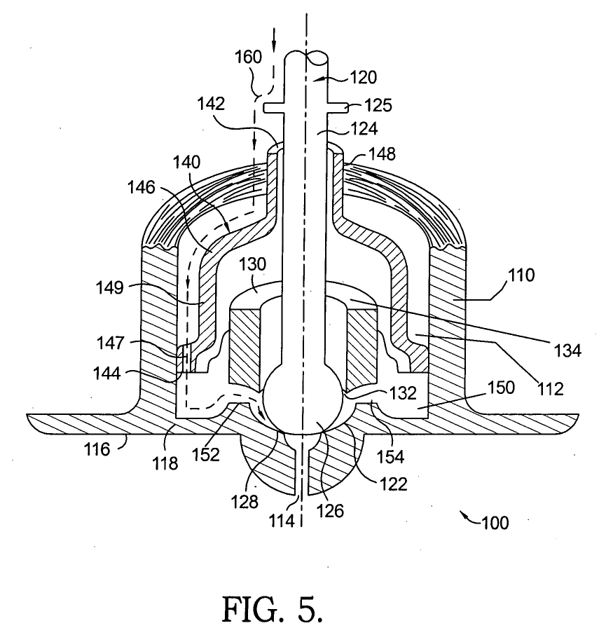

Debris shield 140 may further be integral with lower housing 110 as illustrated in FIG. 5. For example, debris shield 140 may be a stationary part attached to lower housing 110 or may be an integral part of lower housing 110. As shown in FIG. 5, collar 148 is designed to receive pintle shaft 124 such that pintle shaft 124 is moveble within collar 148 in axial direction. Pintle shaft 124 may include a shoulder 125 that is positioned above collar 148 and that radially extends beyond the circumference of collar 148 to divert fuel flow 160 away from pintle shaft 124. Debris shield 140 is attached to or integrated into lower housing 110 such that fuel flow 160 along shoulder 146 and cylindrical section 149 of debris shield 140 is enabled. Debris shield 140 may, for example, be attached to lower housing 110 by attaching tabs. Also, a plurality of flow holes 147 may be integrated into debris shield 140 proximate to the second end 144 but may not be required. Such flow holes 147 may preferably be positioned above particle trap 150. By integrating debris shield 140 into lower housing 110, no mass and therefore no fluid resistance is added to the moving part of fuel injector 100 while protection for sealing area 128 and for lower guide area 132 is provided.

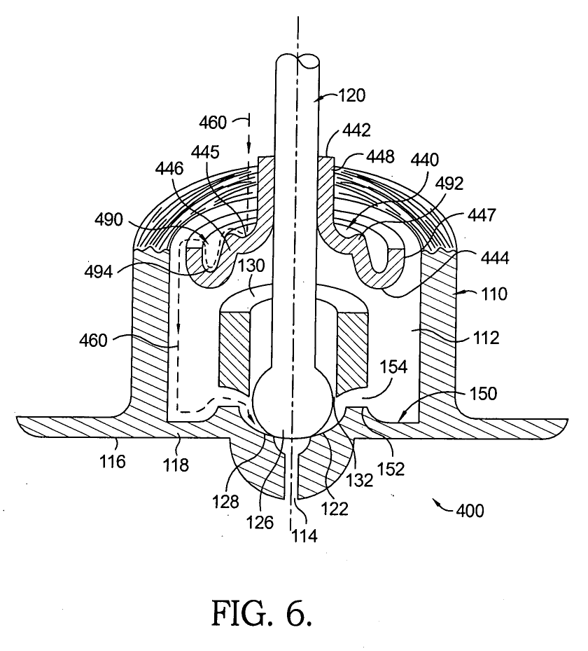

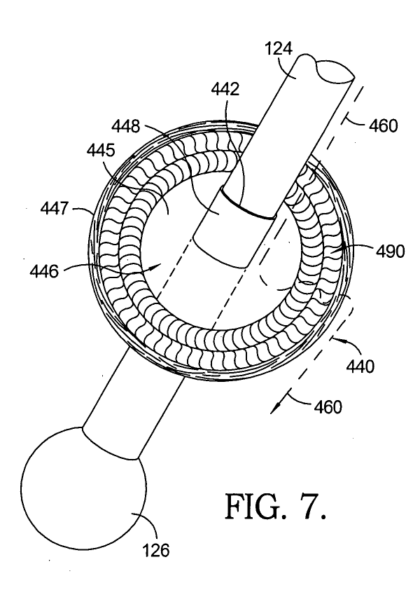

Referring to FIGS. 6 and 7, a fuel injector 400 in accordance with a second embodiment of the invention differs from fuel injector 100 as illustrated in FIGS. 1 and 2 by including a debris shield 440. Accordingly, features identical with those in fuel injector 100 carry the same numbers; features analogous but not identical carry the same numbers but in the 400 series.

Debris shield 440 includes at a first end 442 an attachment collar 448 that may be formed integrally with pintle shaft 124 or may be attached to pintle shaft 124 and a radial flange 446 that extends outwardly from attachment collar 448. Attachment collar 448 ensures that debris shield 140 moves with pintle shaft 124. A particle trap 490 is integrated into debris shield 440. Particle trap 490 is preferably positioned proximate to an outer circumference 447 of debris shield 440, such that an intermediate section 445 of flange 446 is defined between attachment collar 448 and particle trap 490. Outer circumference of flange 446, and therefore debris shield 440, is selected to be larger than the outer circumferential contour of lower guide system 130 to protect lower guide area 132 from contaminations.

Particle trap 490 may include a radially raised rim 492 and a groove 494, both preferably integrally formed with flange 446. Rim 492 is preferably positioned adjacent to intermediate section 445 and groove 494 is preferably positioned proximate to outer circumference 447 of flange 446. The bottom of groove 494 establishes the lower second end 444 of debris shield 440. Debris shield 440 is attached to pintle shaft 124 as not to interfere physically with lower guide system 130.

In operation, a fuel flow 460 passing over debris shield 440 towards fuel outlet 114 is deflected along flange 446 over particle trap 490 towards outer circumference 447. Due to gravity, particles contained in fuel flow 460 may be trapped in particle trap 490. Particle trap 150 positioned in close proximity to valve seat 122 may be included in addition to particle trap 490 (as shown in FIG. 6) or may be eliminated as desired for an application.

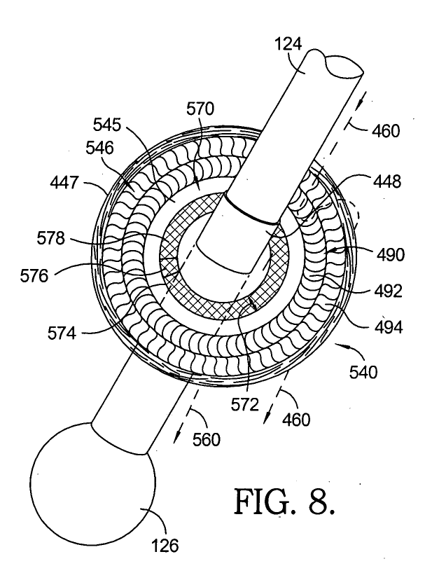

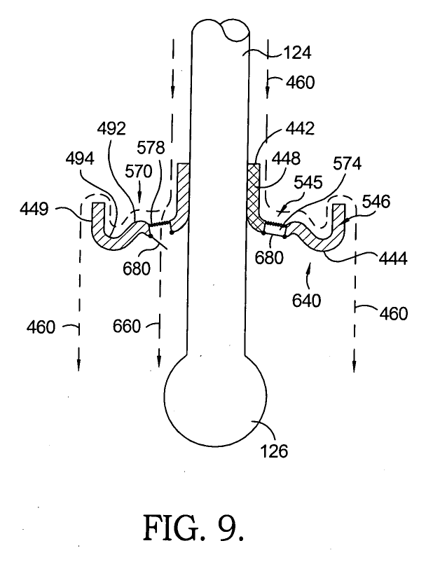

Contrary to debris shield 140 as shown in FIGS. 1 and 2, debris shield 440 as shown in FIGS. 6 and 7 does not create a substantial amount of trapped fuel during the raising movement of valve assembly 120, but hydraulic resistance forces are generated by moving debris shield 440 within fuel passage 112. The magnitude of the hydraulic resistance forces is a function of the effective solid surface area of debris shield 440, such as the surface area of flange 446, and may thus be altered by altering the effective solid surface area of debris shield 440. The hydraulic resistance forces acting upon valve assembly 120 may result in a reduction of the lowering speed, which may be beneficial to reduce the impact force delivered to valve seat 122 by ball 126. While full reduction of the lowering and raising speed of valve assembly 120 and the resultant protection for seat 122 may be desirable for applications at lower speed, it may not be desirable for high speed applications of fuel injector 400. Therefore, alternative debris shields are provided as shown in FIGS. 8 and 9 in accordance with the second embodiment of the invention.

Referring to FIG. 8, a debris shield 540 in accordance with the second embodiment of the invention includes a permeable area 570. Permeable area 570 may be similar in form and function as permeable area 270 shown in FIG. 3. (Note, features identical with those in fuel injector 100 and fuel injector 400 as shown in FIGS. 1 and 6, respectively, carry the same numbers; features analogous but not identical carry the same numbers but in the 500 series.)

Permeable area 570 is an area that enables a certain amount of fuel flow 160, such as partial fuel flow 560, to axially pass through debris shield 540 in both directions. In addition, permeable area 570 prevents particles contained in fuel flow 160 to pass through debris shield 540 and into lower guide area 132.

Permeable area 570 is preferably positioned in an intermediate section 545 of a radial flange 546 of debris shield 540. While permeable area 570 is shown in FIG. 8 to form a complete circle, it may be possible that permeable area 570 forms only a partial circle. The width 572 of permeable area 570 may be chosen according to the desired flow through debris shield 540. Permeable area 570 may be formed, for example, of a mesh material 578 that is attached to or integrated into flange 546 of debris shield 540 covering a previously formed opening 574. It may further be possible to form a plurality of openings 576 that have a smaller surface area than opening 574 in flange 546. Openings 576 may be covered with mesh material 578. While mesh material 578 is shown to cover openings 574 or 576 positioned within intermediate section 545 of flange 546, openings 574 or 576 may be integrated into particle trap 490.

Enabling partial fuel flow 560 through debris shield 540 increases the volumetric flow rate of fuel flow 160 through fuel injector 400, which may improve the performance capability of fuel injector 400.

Referring to FIG. 9, a debris shield 640 in accordance with the second embodiment of the present invention includes at least one flapper valve 680 attached to or integral with debris shield 640 and positioned beneath mesh material 578. (Note, features identical with those in fuel injector 100 and fuel injector 400 as shown in FIGS. 1 and 6, respectively, or with those in debris shield 540 as shown in FIG. 8 carry the same numbers; features analogous but not identical carry the same numbers but in the 600 series.) Any device that allows flow in only one direction may be used instead of flapper valve 680.

In operation, when valve assembly 120 is moving upwards or is in a raised position, a first portion of fuel flow 460 moves along the outside of debris shield 640 carrying particles included in fuel flow 460 away from lower guide area 132. A second portion of fuel flow 460, such as partial fuel flow 660, flows downwards through mesh material 578 and flapper valve 680 thereby reducing the suction force acting on debris shield 640. When valve assembly 120 is moving downwards, thus towards seat 122, flapper valve 680 remains closed thereby preventing partial fuel flow 660 and reducing the lowering speed of valve assembly 120 and, thus, the impact force of ball 126 on seat 122.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A protection device for a lower guide system of a fuel injector having a fuel outlet, the protection device comprising:
a debris shield positioned upstream of said lower guide system and deflecting a fuel flow around said lower guide system; and
a particle trap collecting particles contained within said fuel flow.

2. The protection device of claim 1, further comprising a permeable area integrated within said debris shield, said permeable area enabling a portion of said fuel flow to pass through said debris shield in at least a direction toward said fuel outlet.

3. The protection device of claim 1, wherein said particle trap is integral with said debris shield.

4. The protection device of claim 1, wherein said debris shield has an outer circumference that is larger than an outer circumferential contour of said lower guide system.

5. A debris shield for protecting a lower guide system of a fuel injector having a fuel outlet, the debris shield comprising:
an attachment collar positioned at a first end, said first end being positioned upstream from said lower guide system;
a shoulder extending radially outwards from said attachment collar; and
a cylindrical section extending axially downwards from said shoulder to an open second end, said cylindrical section having a diameter adapted to loosely fit over said lower guide system.

6. The debris shield of claim 5, wherein said attachment collar is formed integrally with a pintle shaft of a valve assembly, and wherein said attachment collar follows the reciprocating movement of said pintle shaft.

7. The debris shield of claim 5, wherein said attachment collar attaches to a pintle shaft of a valve assembly, and wherein said attachment collar follows the reciprocating movement of said pintle shaft.

8. The debris shield of claim 5, wherein said debris shield is integral with a lower housing of said fuel injector, and wherein said attachment collar enables reciprocating movement of a pintle shaft.

9. The debris shield of claim 5, wherein said cylindrical section extends beyond an upper end of said lower guide system, and wherein said second end is positioned between an inner circumferential contour of a lower housing of said fuel injector and an outer circumferential contour of said lower guide system.

10. The debris shield of claim 5, wherein said shoulder includes at least one permeable area that enables a fuel flow to pass through said shoulder in a first direction toward said fuel outlet and in a second and opposite direction through said shoulder, and that prevents debris contained in said fuel flow to pass through said shoulder.

11. The debris shield of claim 10, wherein said at least one permeable area includes at least one opening formed in said shoulder and a mesh material covering said opening.

12. The debris shield of claim 10, wherein said permeable area further includes at least one flapper valve positioned beneath said mesh material, wherein said flapper valve enables said fuel flow to pass through said shoulder in said first direction and substantially prevents said fuel flow to pass through said shoulder in said opposite and second direction.

13. The debris shield of claim 10, wherein said permeable area further includes at least one flapper valve positioned above said mesh material, wherein said flapper valve enables said fuel flow to pass through said shoulder in said second direction and substantially prevents said fuel flow to pass through said shoulder in said first direction.

14. The debris shield of claim 5, wherein a particle trap is integrated into a lower housing of said fuel injector, and wherein said particle trap collects particles contained in a fuel flow deflected by said shoulder and said cylindrical section.

15. A debris shield for protecting a lower guide system of a fuel injector comprising:
an attachment collar positioned at a first end;
a radial flange extending outwardly from said attachment collar and having an outer circumference that is larger than an outer circumferential contour of said lower guide system; and
a particle trap integrated within said radial flange, said particle trap having a bottom that defines a second end;
wherein said first end and said second end are positioned upstream of said lower guide system.

16. The debris shield of claim 15, wherein said particle trap is positioned proximate to an outer circumference of said flange.

17. The debris shield of claim 15, wherein said particle trap includes a radially raised rim and a groove, said rim and said groove forming said particle trap.

18. The debris shield of claim 15, wherein an outer circumference of said flange is larger than an outer circumferential contour of said lower guide system.

19. The debris shield of claim 15, wherein said flange further includes a permeable area, said permeable area enabling a fuel flow to pass through said debris shield in at least a first direction.

20. A fuel injector for an internal combustion engine, comprising:
a lower housing enclosing a fuel passage at an outlet of said fuel injector;
a valve assembly disposed within said fuel passage upstream and in close proximity to a valve seat;
a lower guide system guiding a reciprocating axial movement of said valve assembly; and
a debris shield positioned within said fuel passage and connected to said valve assembly upstream of said lower guide system, wherein said debris shield deflect a first fuel flow to flow around the lower guide system.

21. The fuel injector of claim 16, further comprising a particle trap collecting particles contained in said first fuel flow.

22. The fuel injector of claim 21, wherein said particle trap is integrated into said lower housing in close proximity to said valve seat.

23. The fuel injector of claim 21, wherein said particle trap is integrated into said debris shield.

24. The fuel injector of claim 20, wherein said debris shield includes at least one permeable area that enables said second fuel flow to pass through said debris shield in a first direction and through said debris shield in a second and opposite direction and that prevents debris contained within said second fuel flow to pass through said debris shield in said first direction.

25. The fuel injector of claim 20, wherein said debris shield further includes at least one device that enables said second fuel flow to pass through said debris shield in a first direction and that substantially prevents said second fuel flow through said debris shield in a second and opposite direction.
